(19) United States
(12) Patent Application Publication
(10) Pub. No.: US 2016/0046215 A1
(43) Pub. Date: Feb. 18, 2016

(54) AUTOMOBILE SEAT DIVIDER

(71) Applicants: Eric Lebowitz, Mount Kisco, NY (US); Rachelle Cohen, Mount Kisco, NY (US)

(72) Inventors: Eric Lebowitz, Mount Kisco, NY (US); Rachelle Cohen, Mount Kisco, NY (US)

(21) Appl. No.: 14/459,778

(22) Filed: Aug. 14, 2014

(51) Int. Cl. B60N 2/44

(52) U.S. Cl. CPC B60N 2/441

(57) ABSTRACT

A method of assembling a seat divider kit suitable for use in an automobile, wherein the seat divider is collapsible and removable. The seat divider kit comprises of a collapsible shade, a base, hook and loop fasteners, and connectors. The seat divider kit can also include a shade fastener to maintain the collapsible shade in a collapsed position.

### FIELD OF THE INVENTION

The present invention relates to an automobile seat divider, and in particular, to a removable, collapsible seat divider that can be used to separate space in the passenger compartment of an automobile.

### BACKGROUND OF THE INVENTION

People spend a significant amount of time each year in an automobile. For environmental and economic reasons, both carpooling and transporting more than one family member or friend in the same automobile are common. When groups or families travel together in the same automobile, passengers often sit next to each other. The interior of an automobile is a confined space and passengers are usually in close proximity to one another. For a family of four in a standard four-door car, for example, two adults may sit in the front and two children may sit in the back of the automobile. Even if the car ride is short, the children may grow restless from being in the confined space and that can lead to fights or arguments with one another. With an assembled seat divider in place, two children in the backseat of an automobile will not be able to see, bother, or distract one another. The seat divider also serves as a deterrent to children hitting, poking, or otherwise touching each other. Likewise, two adults can be in the backseat of the automobile, such as at night. One adult passenger may want the space to be dark so that he or she can sleep, while the other adult passenger may want to have a reading light, tablet device, or e-book reader turned on. Therefore, it would be beneficial to find a way to divide the space in an automobile so that passengers can have their own space. Because one may not always want to have the space in the automobile divided, it would further be beneficial to have a divider system that is collapsible and removable.

In addition, it would be beneficial to keep an animal in a certain location in the automobile without using a cage. This can be for purposes of separating the animal from another animal or passenger, keeping the animal within reach of the driver or passenger, or keeping the animal in a certain location in the car. A person, for instance, may want to keep his or her dog in the backseat space directly behind the driver's seat to minimize the area of the car that he or she must vacuum to clean up any dog hair. Because the animal can bump against the divider, it is desirable to have the divider made of a material that is durable. The benefits of a hard divider can also be realized when used with children.

For economic and environmental reasons, many car manufacturers sell smaller automobiles. These smaller automobiles are attractive to consumers because they are more affordable, use less gasoline, and can be comparatively better for the environment than many larger cars. But because the overall car size is smaller, the passenger compartment tends to be smaller. This is particularly true with respect to the rear passenger compartment of the car. Again, it would be beneficial to have a divider system that did not take up a lot of space and that was removable.

Because car windows are transparent, they do not provide any privacy or protection from the sun. There are devices available which connect to the car window for sun protection. While these systems can provide shade and privacy, they do not function as a space divider. Thus, it is an improvement on the prior art to have one product that is constructed to divide space, block sun, hide valuables and/or provide privacy based on the automobile user's needs.

Because the interior of an automobile is generally plain, it would be beneficial to have a divider that added an aesthetically pleasing color or style to the automobile. Moreover, it would be desirable to have dividers with prints that entertain or educate children. Such prints can include cartoon characters, letters, the alphabet, words, numbers, or other patterns.

Finally, it would be advantageous to have a space divider that is multi-purpose and versatile. As discussed above, potential uses can include the ability to divide space, hide valuables, protect passengers from the sun, provide privacy, provide entertainment or education to passengers, or for aesthetic reasons at any location on the automobile seat. The present invention's multi-purpose nature distinguishes it from traditional space dividers and sun screens.

### SUMMARY OF THE INVENTION

In accordance with one aspect of the present invention, a method of assembling a seat divider kit suitable for use in an automobile is disclosed. The method is to be used in an automobile that has at least one passenger seat and a roof. The seat divider kit comprises of a collapsible shade, a base, a plurality of hook and loop fasteners, and a plurality of connectors. The method of assembling the seat divider kit comprises connecting a first set of hook and loop fasteners to the seat of the automobile in such a way that the hook and loop fasteners divide the seat into at least two sections, connecting a second set of hook and loop fasteners to the bottom of the collapsible shade base, connecting the collapsible shade to the base, connecting a first set of connectors to the collapsible shade at the opposite end from the base, and connecting a second set of connectors to the roof the automobile.

In other aspects of the invention, after the second set of connectors is connected to the roof of the automobile, the method includes placing the collapsible shade in a collapsed position and connecting the second set of hook and loop fasteners on the base of the collapsible shade to the first set of hook and loop fasteners on the seat of the automobile.

In another embodiment, the seat divider kit consists of a collapsible shade with a base that has a first set of hook and loop fasteners on the bottom of the base and a second set of hook and loop fasteners capable of being connected to the seat of the automobile. The collapsible shade also has a first set of connectors located on the end opposite of its base. The seat divider kit further comprises a second set of connectors that are capable of being connected to the roof of the automobile and engaging with the first set of connectors. For this seat divider kit, the method of assembly comprises connecting the second set of hook and loop fasteners to the seat of the automobile such that the hook and loop fasteners divide the seat into at least two sections, connecting the second set of connectors to the roof of the automobile, and connecting the first set of hook and loop fasteners on the bottom of the base to the second set of hook and loop fasteners on the seat of the automobile.

The above described methods can then include extending the collapsed shade vertically to the roof of the automobile and engaging the first set of connectors of the shade with the second set of connectors on the roof of the automobile. In certain embodiments, the seat divider kit is assembled for use in the backseat of the automobile.

Furthermore, another aspect of the inventive method includes removing the collapsible shade and base from the automobile. The invention also includes a shade fastener to maintain the collapsible shade in a collapsed position and a method of releasing the collapsible shade from its collapsed position prior to performing any of the connections. In certain embodiments, the shade fastener is comprised of two pieces that are connected to the left and right side of the collapsible shade base. The shade fastener can be secured into place in any suitable manner, including by using hook and loop fasteners.

Other aspects of the seat divider assembly kit can include a collapsible shade that is opaque or made of a hard material, such as plastic.

It will be appreciated that this invention can be applicable to other vehicles that have at least one seat and a roof. This invention can also be used with a variety of fasteners and connectors, and not just hook and loop fasteners.

These and other aspects, features and advantages shall be apparent from the accompanying drawings and description of certain embodiments of the invention.

### BRIEF DESCRIPTION OF THE DRAWINGS

FIG. 1 depicts a flowchart of the steps performed when assembling a seat divider kit according to one embodiment of the invention;

FIG. 2 is a cross-sectional view of an assembled seat divider kit according to one embodiment of the invention;

FIG. 3 is a perspective view of an assembled seat divider kit according to one embodiment of the invention;

FIG. 4 is a partially enlarged view of the top of FIG. 2;

FIG. 5 is a partially enlarged view of the bottom of FIG. 2;

FIG. 6 is a top plan view of an assembled seat divider kit according to one embodiment of the invention;

FIG. 7 is a bottom plan view of an assembled seat divider kit according to one embodiment of the invention;

FIG. 8 is a top plan view of a hook and loop fastener capable of being connected to an automobile seat according to one particular embodiment of the invention; and

FIG. 9 is a perspective view of an assembled seat divider kit in a collapsed position with a shade fastener according to one embodiment of the invention.

### DETAILED DESCRIPTION OF CERTAIN EMBODIMENTS OF THE INVENTION

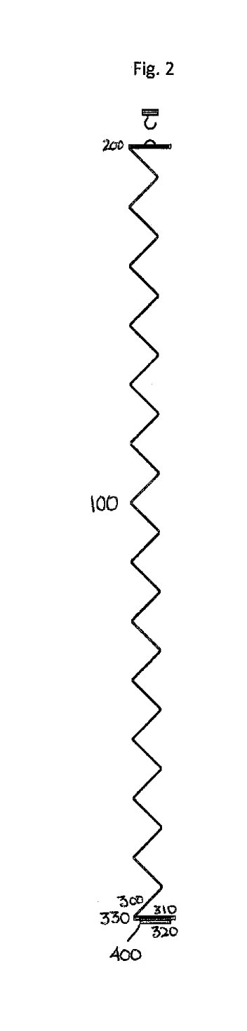

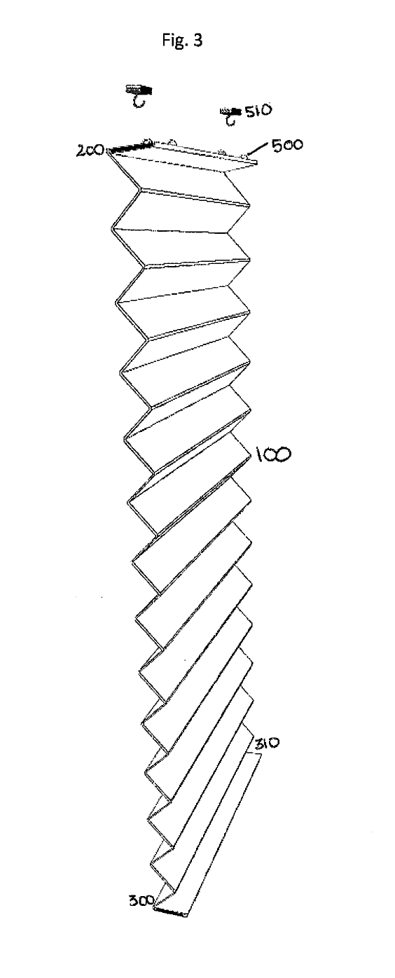

The disclosed invention is primarily intended for use in an automobile. Unlike traditional space dividers, the present invention is collapsible and removable. Because space and storage in the passenger compartment of an automobile can be constrained, the collapsible and removable nature of embodiments the invention is important. Its removability also provides users with the flexibility to move the seat divider to a new location, as desired. Another important aspect of certain embodiments of the invention that distinguishes it from typical space dividers is that it can have an accordion design, as shown in FIGS. 2-3. In certain embodiments, the divider can be collapsed in other ways, such as being rolled into a roller. Embodiments that use either an accordion or roller design are advantageous because they can be extended to fit a variety of automobiles.

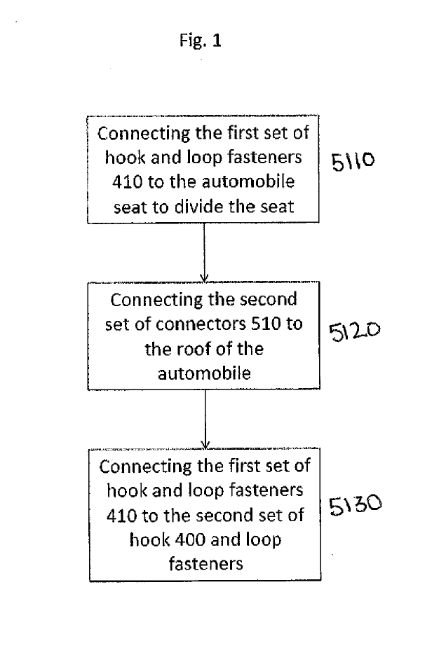

Referring to FIGS. 1-3, a seat divider kit can be assembled that is suitable for use in an automobile that has at least one seat and a roof. In some embodiments, the automobile seat comprises a horizontal seat and a seat back. The seat divider kit contains the following components, which can be pre-assembled or assembled by the user: a collapsible shade 100 with a top end 200 and a bottom end 300, a base 330 with a top end 310 and a bottom end 320, a plurality of hook and loop fasteners 400 and 410, and a plurality of connectors 500 and 510. The kit can also include a shade fastener 600.

In a preferred embodiment, the seat divider kit is assembled for use in the rear passenger compartments of an automobile. In this embodiment, the seat divider kit is connected to the backseat of the automobile. For automobiles with two or more rows of seats, the backseat includes all seats that are not the front driver and front passenger seats of the automobile. In one embodiment, the backseat includes the middle and third row of seats. While the preferred embodiment is for use in the rear passenger compartments of an automobile, it is appreciated that the seat divider kit can be assembled or used on any automobile seat, including the front seat of the automobile in certain other embodiments.

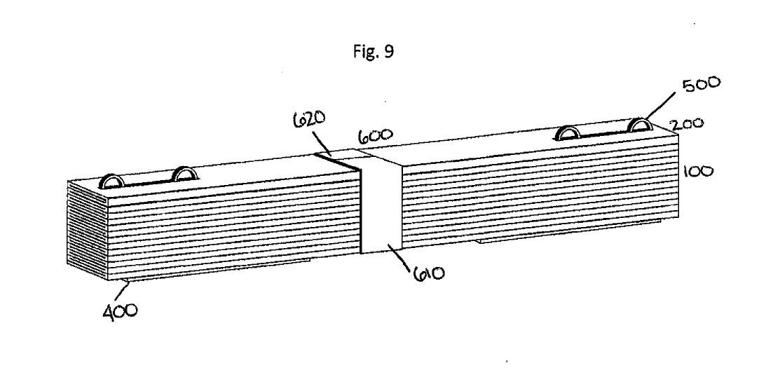

The collapsible shade 100, as shown in FIG. 9, has the capability to collapse to minimize storage space for when the seat divider is not in use. Because of the accordion design of this embodiment, the collapsible shade 100 can be extended to fit a variety of spaces. For larger automobiles, such as SUVs or trucks that have more vertical space between the seat and the roof, the collapsible shade 100 can be extended as needed to fit the space. The maximum extension for the collapsible shade 100 in the embodiment shown in FIGS. 2, 3 and 9 is the point where the shade is straight and no longer has any accordion folds. If the space that needs to be divided is smaller, then the collapsible shade 100 will not be extended as far, and its accordion folds will be closer together. Other embodiments that utilize a roller for the collapsible shade 100 can similarly be unrolled to fit a variety of spaces. Any suitable roller can be used. The collapsible shade 100 can be made of any suitable material, including fabric, wood, and plastic. In certain embodiments where an accordion design is used, the material must be able to be folded into an accordion position. If a hard or rigid material is used for the accordion design, the joints of the accordion shade must be flexible so that it can be collapsed, as shown in FIG. 9. If constructed to roll, then the material of the collapsible shade 100 is to be selected to accommodate such construction (e.g. vinyl, fabric, canvas). The type of material of collapsible shade 100 will depend on the user's desired use and required durability for the seat divider. If the intended use of the seat divider is for passenger privacy, then any material can be suitable. However, if the intended use is to separate young children or for use with animals, it can be advantageous for the collapsible shade 100 to be an accordion design and made of a hard material, such as plastic or wood, so that it has sufficient durability. The collapsible shade 100 can also be any suitable color, pattern or transparency for the desired use. For example, to hide valuables, the user may want the divider to be opaque so that what is on the other side of the divider cannot be seen. Or, the user may want to have a color or pattern on the collapsible shade 100 to add an aesthetically pleasing decorative aspect to the automobile or to educate or entertain children. Children may enjoy seeing their favorite cartoon characters reproduced on the collapsible shade 100. Or, the collapsible shade 100 can contain letters or words to assist a child that is learning the alphabet or to read. In certain embodiments, each side of the collapsible shade 100 has a different style or pattern.

The use of an accordion design in certain embodiments is the preferred embodiment because the entire shade does not need to be flexible to collapse and does not require the use of a roller. When a roller is used, the shade can get stuck in the roller. Accordion configurations are known in the art, and typically are used in window blinds or as a foldable door. Accordion window blinds, also known as pleated shades, hang from the top of a window and utilize a pull string to move the blind up and down. These window blinds are connected to the window or wall only at the top of the window blind. Foldable doors that utilize an accordion shade are folded along a track in or near the top of the door frame, and can also have a handle to assist in folding the door. The collapsible shade 100 that uses an accordion design in certain embodiments differs from these prior art accordion configurations at least because it is constructed with connectors to engage two spaced automobile surfaces, namely, using connections 400 and 500 at both the top and bottom end of the collapsible accordion shade 100. Moreover, the shade 100 does not utilize a pull string, track or handle, and is easily removed.

The collapsible shade 100 has a top end 200 and a bottom end 300, as shown in FIGS. 2-5. The seat divider kit also includes a base 330 with a top end 310 and a bottom end 320. The top end 310 of the base 330 is connectable to the bottom end 300 of the collapsible shade 100. The base 330 can be of any suitable material that is sufficiently durable to withstand the assembly and removal of the base from the automobile. In certain embodiments, plastic or another hard material is used for the base 330.

A first set of hook and loop fasteners 410, shown in FIG. 8, are capable of being connected to the automobile seat, regardless of whether the seat is fabric, leather or any other material, In certain embodiments, the first set of hook and loop fasteners 410 are connected to the automobile seat so that it divides the seat into at least two sections. It can be appreciated that the divided sections do not need to be fully closed off. In other embodiments, the first set of hook and loop fasteners 410 are connected to the automobile seat so that they are perpendicular to the seat back. The first set of hook and loop fasteners 410 can be connected to the automobile seat in any suitable manner, including by the use of adhesive or tape. A second set of hook and loop fasteners 400 are connectable to the bottom end 320 of the base 330, and such connection can be made by the manufacturer prior to the kit being sold or by the user during assembly. As used herein, hook and loop fastener refers to any suitable fastener. While any suitable fastener can be used in the present invention, common brands of hook and loop fasteners that can be used in certain embodiments include Velcro® and DuraGrip®. The size, weight and use of the collapsible shade 100 will determine the number of hook and loop fasteners 400 and 410 that are necessary. In certain embodiments, the number of hook and loop fasteners 400 are less than the number of hook and loop fasteners 410.

Referring to FIGS. 2-4, a first set of connectors 500 are connectable to the top end 200 of the collapsible shade 100. The number of connectors in the first set of connectors 500 can be determined by the size and weight of the collapsible shade 100 and its intended use. In a preferred embodiment, as shown in FIGS. 3 and 6, the first set of connectors 500 contains four loop-shaped connectors which are affixed adjacent to each other along the middle of the top end 200 of the collapsible shade 100.

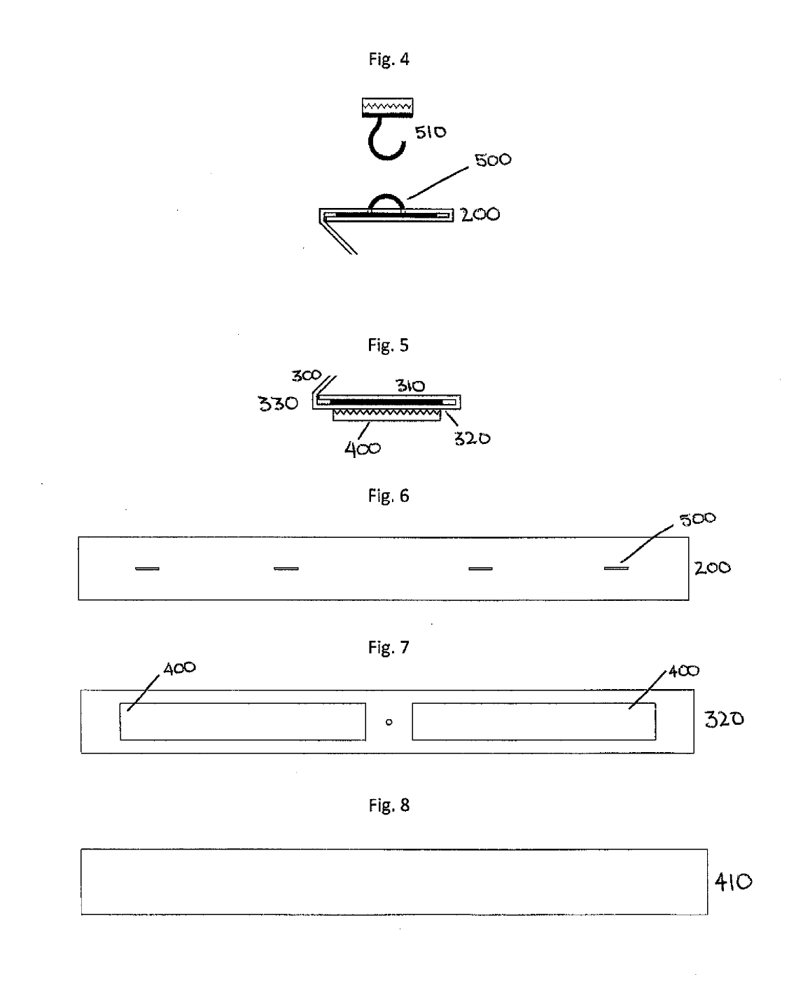

A second set of connectors 510 are capable of being connected to the roof of the automobile. The second set of connectors 510 can utilize any suitable connection method and position that will allow the second set of connectors 510 to engage with the first set of connectors 500. In certain embodiments, a hook connector, as shown in FIGS. 3-4, can be used. In these embodiments, the hook connector is attached to the roof such that the hooks are perpendicular to and capable of being moved through the loop-shaped connectors on the top end 200 of the collapsible shade 100, resulting in the hooks engaging with the loop-shaded connectors.

The number of connectors in the second set of connectors 510 can be the same as the number of connectors in the first set of connectors 500 such that all connectors in the first and second sets 500 and 510 can be engaged. However, it is appreciated that there only needs to be a sufficient number of connectors in the second set of connectors 510 to hold the collapsible shade 100 in an extended position. In a preferred embodiment, as shown in FIG. 3, the first set of connectors 500 contains four connectors and the second set of connectors 510 contains two connectors. Depending on the size of the vehicle and the location where the user desires to place the divider, in this embodiment, the user selects which connectors from the first set of connectors 500 will engage with the two connectors from the second set of connectors 510.

In the preferred embodiment, as shown in FIGS. 2-4, the first set of connectors 500 are loop-shaped connectors and the second set of connectors 510 are hooks. It is appreciated that any suitable connectors can be used. The loop-shaped connectors and hooks are preferred because they allow for a quick and noiseless connection.

Because of space constraints and for purposes of storage, it is desirable to be able to collapse the assembled seat divider kit and maintain it in a collapsed position. In certain embodiments, the collapsible shade 100 is maintained in place by a shade fastener 600, as shown in FIG. 9. The shade fastener 600 can be any suitable size, shape, and material to maintain the collapsible shade 100 in a collapsed position. Referring to FIG. 9, a further embodiment utilizes a shade fastener 600 configuration where the shade fastener 600 consists of two pieces 610 and 620. The shade fastener pieces 610 and 620 are connected to either side of the base 330. To engage the shade fastener 600, the two shade fastener pieces 610 and 620 are brought together and connected on the top end 200 of the collapsible shade 100. The shade fastener pieces 610 and 620 can be connected in any suitable manner, such as by a snap or sets of hook and loop fasteners. If hook and loop fasteners are used, a third set of hook and loop fasteners will be connected to shade fastener piece 610 and a fourth set of hook and loop fasteners will be connected to shade fastener piece 620. The shade fastener pieces 610 and 620 can then be joined together so that the third and fourth set of hook and loop fasteners engage such that the shade fastener 600 maintains the collapsible shade 100 in a collapsed position. In embodiments where the collapsible shade 100 arrives in a collapsed position, either through use of a shade fastener 600 or otherwise, the user will need to release the shade fastener 600 or release the shade 100 from its collapsed position prior to assembly. In a further embodiment, after the connecting steps, the shade 100 is collapsed so that it sits along the base 330. When the collapsible shade 100 is in this position, the second set of hook and loop fasteners 400 on the bottom 320 of the base 330, as shown in FIG. 7, are connected to the first set of hook and loop fasteners 410 on the seat of the automobile. When the first and second sets of hook and loop fasteners 400 and 410 are engaged, the collapsed shade 100 is secured in place.

Turning back to FIG. 1, this embodiment includes several steps to assemble a seat divider kit. The method is for assembling a seat divider kit for use in an automobile, so the user must have an automobile with at least one seat and a roof. The seat divider kit includes a collapsible shade 100 with a top end 200 and bottom end 300, a base 330 with a top end 310 and bottom end 320, a plurality of hook and loop fasteners 400 and 410, and a plurality of connectors 500 and 510. In this embodiment, the collapsible shade 100, base 330, second set of hook and loop fasteners 400, and first set of connectors 500 are already connected. These pieces of the seat divider kit are connected such that the second set of hook and loop fasteners 400 are connected to the bottom end 320 of the base 330, the top end 310 of the base 330 is connected to the bottom end 300 of the collapsible shade 100, and the first set of connectors 500 are connected to the top 200 of the collapsible shade 100. The connection of these pieces can be done by the manufacturer of the seat divider kit or the user prior to assembly. It is preferred that these pieces are pre-assembled by the manufacturer so as to minimize the number of steps that the user needs to complete to assemble the seat divider kit. Referring back to FIG. 1, in the first step 5110 of this embodiment, the user connects the first set of hook and loop fasteners 410 to the seat of the automobile in such a way that the seat is divided into at least two sections. This can include connecting the first set of hook and loop fasteners 410 in the middle of the horizontal portion of the seat, perpendicular to the seat back. Next, the user connects the second set of connectors 510 to the roof of the automobile, as shown in step 5210 in FIG. 1. Finally, the user connects the first set of hook and loop fasteners 410, which are on the seat of the automobile, to the second set of hook and loop fasteners 400, which are on the bottom end 320 of the base 330. This is shown in step 5130 of FIG. 1. In this embodiment, the collapsible shade 100 is secured to the automobile seat, but it has not yet been extended.

In another embodiment for assembling a seat divider kit, the seat divider kit that is assembled includes only a collapsible shade 100 with a top end 200 and bottom end 300, a base 330 with a top end 310 and bottom end 320, a plurality of hook and loop fasteners 400 and 410, and a plurality of connectors 500 and 510. In this embodiment, the collapsible shade, base, hook and loop fasteners, and connectors are not yet connected. The user connects the first set of hook and loop fasteners 410 to the seat of the automobile in such a way to divide the seat in at least two sections. The user then connects a second set of hook and loop fasteners 400 to the bottom end 320 of the base 330. In order to attach to collapsible shade 100 and the base 330, the user connects the top end 310 of the base 330 to the bottom end 300 of the collapsible shade 100. Next, the user connects the first set of connectors 500 to the top end 200 of the collapsible shade 100. Lastly, the user connects a second set of connectors 510 to the roof of the automobile.

Other embodiments include additional steps for assembling the seat divider kit. In certain embodiments, the user places the shade in a collapsed position on the base 330 and engages the second set of hook and loop fasteners 400 with the first set of hook and loop fasteners 410. In this embodiment, the collapsible shade is secured to the seat in a collapsed position. In another embodiment, once the collapsible shade 100 is secured to the seat, the user extends the collapsible shade vertically to the roof of the automobile and engages the first set of connectors 500 with the second set of connectors 510 on the roof of the automobile. In certain embodiments, the use completes this step by unfolding an accordion shade and securing a set of hooks on the roof of the automobile through a set of loop-shaped connectors on the top of the accordion shade.

Furthermore, other embodiments include steps to remove the seat divider kit. In one embodiment, after the collapsed shade is secured to the seat of the automobile, the user removes it and the base 330. This is accomplished, in certain embodiments, by the user disengaging the first set of hook and loop fasteners 400 on the bottom end 320 of the base 330 with the second set of hook and loop fasteners 410 on the seat of the automobile. The user can disengage these fasteners by pulling on the base 330.

In other embodiments, prior to assembly, the user must release the collapsible shade 100 from its collapsed position.

Depending on the desired use, the user can connect the second set of connectors 510 on the roof of the automobile at a position that vertically spaced directly above the first set of hook and loop fasteners 410. It is appreciated that the second set of connectors 510 do not need to be directly above the first set of hook and loop fasteners 410. For example, the second set of connectors 510 can be offset a certain distance so that when the collapsible shade 100 is extended, it is extended in a diagonal configuration.

It is appreciated that the steps of the above described methods of assembling the seat divider kit can be performed in any order and on any seat in an automobile, including the back and front seats. It is also appreciated that the extension of the collapsible shade 100 can occur in any direction. For example, the user can assemble the seat divider kit by first engaging the first set of connectors 500 with the second set of connectors 510 on the roof of the automobile, and then extending the collapsible shade 100 downward toward the automobile seat so that the first and second set of hook and loop fasteners 400 and 410 can be connected.

The terminology “first set,” “second set,” “third set” and “fourth set” are used herein for convenience. It is appreciated that a “set” can include one or more than one item. For example, the first set of connectors 500 can include only one connector, or multiple connectors.

While the invention has been described in connection with certain embodiments, it is defined by the claims that accompany this description and is not to be read as being restricted to any one embodiment thereof.

1. A method of assembling a seat divider kit suitable for use in an automobile that has at least one seat and a roof, which includes a collapsible shade having a top end and a bottom end, a base with a top end and bottom end, a plurality of hook and loop fasteners, and a plurality of connectors, comprising:
connecting a first set of hook and loop fasteners to the seat of the automobile
wherein the first set of hook and loop fasteners divides the seat into at least two sections;
connecting a second set of hook and loop fasteners to the bottom end of the base;
connecting the top end of the base to the bottom end of the collapsible shade;
connecting a set of loop connectors to the top end of the collapsible shade; and
connecting a set of hook connectors to the roof of the automobile.

2. The method as in claim 1, including the additional step, after the connecting steps, of placing the collapsible shade in a collapsed position so that it sits on the base, wherein the second set of hook and loop fasteners on the base are connected to the first set of hook and loop fasteners on the seat of the automobile.

3. The method as in claim 2, including the additional step, after the connecting and placing steps, of extending the collapsible shade vertically to the roof of the automobile and hookedly engaging the set of loop connectors on the top end of the collapsible shade with the respective hook connectors on the roof of the automobile.

4. The method as in claim 2, including the additional step, after the connecting steps, of removing the collapsible shade and base.

5. The method as in claim 1, including the additional step, prior to the connecting steps, of releasing the collapsible shade from its collapsed position.

6. The method as in claim 1, wherein the connecting step of the first set of hook and loop fasteners is with a backseat of the automobile.

7. A method of assembling a seat divider kit suitable for use in an automobile that has at least one seat and a roof, which includes a collapsible shade having a top end and a bottom end, a base with a top end and bottom end wherein the top end of the base is connected to the bottom end of the collapsible shade, a plurality of hook and loop fasteners wherein a first set of hook and loop fasteners are capable of being connected to the seat of the automobile and a second set of hook and loop fasteners are connected to the bottom end of the base, and a plurality of connectors wherein a set of loop connectors are connected to the top end of the shade and a set of hook connectors are capable of being connected to the roof of the automobile, comprising:
connecting a first set of hook and loop fasteners to the seat of the automobile wherein the first set of hook and loop fasteners divides the seat into at least two sections;
connecting a set of hook connectors to the roof of the automobile; and
connecting the second set of hook and loop fasteners on the bottom end of the base to the first set of hook and loop fasteners on the seat of the automobile.

8. The method of claim 7, including the additional step, after the connecting steps, of extending the collapsible shade vertically to the roof of the automobile and hookedly engaging the set of loop connectors on the top end of the collapsible shade with the respective hook connectors on the roof of the automobile.

9. The method as in claim 7, including the additional step, after the connecting steps, of removing the collapsible shade and base.

10. The method as in claim 7, including the additional step, prior to the connecting steps, of releasing the collapsible shade from its collapsed position.

11. The method as in claim 7, wherein the connecting step of the second set of hook and loop fasteners is with a backseat of the automobile.

12. A seat divider kit for an automobile with at least one seat and a roof, comprising:
a collapsible shade with a top end and a bottom end;
a first and a second set of hook and loop fasteners, wherein the first set of hook and loop fasteners are attachable to the seat of the automobile;
a base with a top end and a bottom end, wherein the top end of the base is attached to the bottom end of the collapsible shade and the bottom end of the base is connected to a second set of hook and loop fastener;
a set of loop connectors, which are connected to the top end of the collapsible shade; and
a set of hook connectors, which are attachable to the roof of the automobile and capable of hookedly engaging with the set of loop connectors.

13. The seat divider kit assembly as in claim 12, further comprising a shade fastener to maintain the collapsible shade in a collapsed position.

14. The seat divider kit assembly as in claim 12, wherein the collapsible shade is opaque.

15. The seat divider kit assembly as in claim 12, wherein the collapsible shade is made of plastic.

16. The seat divider kit assembly as in claim 12, wherein the collapsible shade is made of fabric.

17. The seat divider kit assembly as in claim 13, wherein the base has a left side and a right side, the shade fastener comprises a left piece and a right piece such that the left piece of the shade fastener is connected to the left side of the base and the right piece of the shade fastener is connect to the right side of the base.

18. The seat divider kit assembly as in claim 17, further comprising a third and fourth set of hook and loop fasteners such that the third set of hook and loop fasteners is connected to the left piece of the shade fastener and the fourth set of hook and loop fasteners is connected to the right piece of the shade fastener, wherein the left piece of the shade fastener and right piece of the shade fastener can be joined together to maintain the collapsible shade in a collapsed position.

19. The seat divider kit assembly as in claim 12, wherein the collapsible shade is a collapsible accordion shade.

20. The seat divider kit assembly as in claim 12, further comprising a roller wherein the collapsible shade can rolled into the roller.
